(19) United States
(12) Patent Application Publication
(10) Pub. No.: US 2018/0376456 A1
(43) Pub. Date: Dec. 27, 2018

(54) RADIO COMMUNICATION SYSTEM, MOBILE STATION, USER INTERFACE, AND DISPLAY METHOD

(71) Applicant: NEC CORPORATION, Tokyo (JP)

(72) Inventor: Takahiro TSUTSUI, Tokyo (JP)

(73) Assignee: NEC CORPORATION, Tokyo (JP)

(21) Appl. No.: 15/778,075

(22) PCT Filed: Dec. 13, 2016
(86) PCT No.: PCT/JP2016/087006

§ 371 Date: May 22, 2018

(30) Foreign Application Priority Data
Dec. 15, 2015 (JP) 2015-244273

(51) Int. Cl. H04W 72/02; H04M 1/725; H04W 24/02; H04W 72/04; H04W 72/08; H04L 5/00

(52) U.S. Cl. CPC H04W 72/02; H04M 1/72569; H04W 24/02; H04W 72/048; H04W 72/085; H04L 5/0032; H04W 72/0453

(57) ABSTRACT

A radio communication system for providing a configuration for adding a new cell includes a mobile station, and a base station including a first cell having a first carrier wave frequency and a second cell having a second carrier wave frequency. When the mobile station is performing radio communication with the base station using the first cell, input information necessary for performing said radio communication with the first cell and the second cell is input. The mobile station transmits transmission information generated on the basis of the input information. The base station receives the transmission information.

### TECHNICAL FIELD

The present disclosure relates to a radio communication system, a mobile station, a base station, a user interface, and a display method.

### BACKGROUND ART

According to PTL 1, in a mobile communication system of a long term evolution (LTE)-Advanced scheme, a mobile station (user equipment, UE) can perform carrier aggregation (CA) communication by using a primary component carrier (PCC) and one or more secondary component carriers (SCCs) having a carrier wave frequency different from that of the PCC. Further, in the mobile communication system of the LTE-Advanced scheme, a primary cell (Pcell) which is a serving cell in the PCC and a secondary cell (Scell) which is a serving cell in the SCC can be set to the mobile station (UE) that is performing the CA communication.

In PTL 2, a radio base station (evolved Node B, eNB) sets “Measurement Configuration” to a mobile station (UE). The mobile station (UE) performs measurement processing, based on the “Measurement Configuration”, and reports a measurement result to the radio base station (eNB). The radio base station (eNB) adds a cell specified by the measurement report, as an Scell in the CA.

### CITATION LIST

### Patent Literature

[PTL 1] Japanese Unexamined Patent Application Publication No. 2012-5089

[PTL 2] Japanese Unexamined Patent Application Publication No. 2014-135598

### SUMMARY OF INVENTION

### Technical Problem

In PTLs 1 and 2, processing of adding a cell is led by a radio base station.

However, there is a possibility that the addition of a cell may be inappropriate depending on a situation of a mobile station. For example, when the mobile station is in motion and time during which the mobile station camps in a coverage area of a cell is short, there is a possibility that addition of the cell may be inappropriate. Further, when the mobile station camps in a coverage area of a cell for a certain period or longer for such reasons that the mobile station is stopped or moving at a low speed, there is a possibility that addition of the cell may be appropriate.

Accordingly, one object of an example embodiment is to provide a new configuration for adding a cell. Note that this object is merely one of a plurality of objects to be achieved by example embodiments disclosed in the present description. Other objects or problems, and novel features will become apparent from the descriptions or the accompanying drawings in the present description.

### Solution to Problem

A radio communication system according to an example embodiment comprises: a mobile station; and a base station including a first cell having a first carrier wave frequency and a second cell having a second carrier wave frequency. The mobile station inputs, when radio communication with the base station is performed by using the first cell, input information necessary for performing the radio communication by using the first cell and the second cell. The mobile station transmits transmission information generated based on the input information. The base station receives the transmission information.

A mobile station according to another example embodiment comprises: a user interface; and a transmitter. The user interface is configured to input, when radio communication with a base station is performed by using a first cell having a first carrier wave frequency, input information necessary for performing the radio communication by using the first cell and a second cell having a second carrier wave frequency. The transmitter is configured to transmit transmission information generated based on the input information.

A base station according to another example embodiment comprises: a first cell having a first carrier wave frequency; a second cell having a second carrier wave frequency; and a receiver. The receiver is configured to receive transmission information. The transmission information is generated based on input information that is input in the mobile station when radio communication with a mobile station is performed by using the first cell, and necessary for performing the radio communication by using the first cell and the second cell.

A user interface according to another example embodiment performs, when radio communication with a base station is performed by using a first cell having a first carrier wave frequency, display for inputting input information necessary for using the first cell and a second cell having a second carrier wave frequency for the radio communication.

A display method according to another example embodiment comprises: performing, when radio communication with a base station is performed by using a first cell having a first carrier wave frequency, display for inputting input information necessary for using the first cell and a second cell having a second carrier wave frequency for the radio communication.

### Advantageous Effects of Invention

According to an example embodiment, it is possible to provide a new configuration for adding a cell.

### BRIEF DESCRIPTION OF DRAWINGS

FIG. 1 illustrates a radio communication system of a first example embodiment.

FIG. 2 illustrates a mobile station of the first example embodiment.

FIG. 3 illustrates a base station of the first example embodiment.

FIG. 4 illustrates an operation of the first example embodiment.

FIG. 5 illustrates an example of a reference signal according to the first example embodiment.

FIG. 6 illustrates a display example 1 in an output device of the mobile station of the first example embodiment.

FIG. 7 illustrates a display example 2 in the output device of the mobile station of the first example embodiment.

FIG. 8 illustrates a display example 3 in the output device of the mobile station of the first example embodiment.

FIG. 9 illustrates an operation of a second example embodiment.

FIG. 10 illustrates an operation of a third example embodiment.

FIG. 11 illustrates a mobile station of a fourth example embodiment.

FIG. 12 illustrates a base station of the fourth example embodiment.

### EXAMPLE EMBODIMENT

Example embodiments (exemplary embodiments) will be described in detail with reference to the drawings. In the drawings, identical or corresponding elements are denoted by the same reference numerals and repeated explanations are omitted as needed for clarity of explanation. A plurality of example embodiments described below may be independently carried out or may be carried out in combination as needed.

In the present description and the drawings, a plurality of components including substantially the same function may be distinguished from each other using different alphabets added to the same reference numeral.

### INTRODUCTION

In the LTE-Advanced scheme, an evolved universal terrestrial access network (E-UTRAN) is composed of various types of base stations. Each cell formed by the base stations forms a heterogeneous network (HetNet).

In the HetNet, a macro cell formed by a normal base station overlays a pico cell, a small cell, a femto cell, or the like, which is formed by a small base station.

In the HetNet, CA is used. The CA is used to improve the throughput of a U (User)-Plane of a mobile station (UE: User Equipment).

In the CA, under the HetNet environment including different carrier wave frequencies and overlapping coverages, a group of a plurality of cells (within an Intra eNB) in the base station (eNB) simultaneously performs U-Plane communication.

A group of a plurality of cells includes a primary cell (Pcell) and a secondary cell (Scell). Herein, the Pcell is a cell that performs U-Plane or C (Control)-Plane communication. The secondary cell (S cell) is a cell that performs U-Plane communication.

In the CA, the eNB instructs the UE to measure a frequency at which the Scell is to be added, and the eNB obtains the quality of the measurement result from the UE and determines the S cell.

### First Example Embodiment

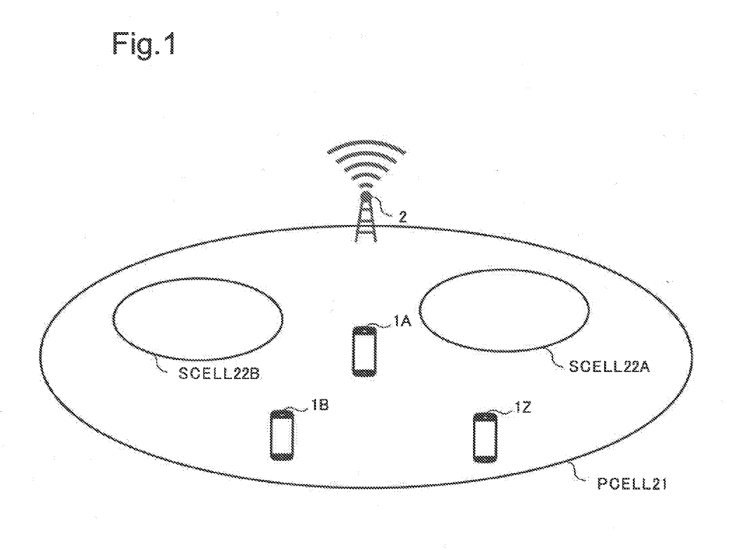

FIG. 1 illustrates a radio communication system of a first example embodiment.

The radio communication system illustrated in FIG. 1 includes at least one mobile station 1 and a base station 2. Further, the base station 2 includes a Pcell 21 and at least one Scell 22. The Pcell 21 and the Scell 22 are constituted by the base station 2.

In this case, the Scell 22 may be related not only to a frequency band for which a license is required, but also to a frequency band for which a license is not required. For example, a 5-GHz band (unlicensed band) for which a license is not required at a specific output or lower. A scheme of performing LTE communication by using the unlicensed band is referred to as licensed assisted access using LTE (LAA). In the following description, a cell using the unlicensed band is referred to as an LAA-cell.

In an example of FIG. 1, a frequency band for which a license is required is used for the Pcell 21. An LAA-cell is used as the Scell 22. Thus, the CA in a downlink (DL) is performed and the throughput can be improved. However, for example, in the 5-GHz band, Wi-Fi (wireless LAN) is also used. When there are different systems in the same frequency band, a configuration for allowing different systems to coexist is used.

One configuration is a listen before talk (LBT) function. The LBT function is to carry out clear channel assessment (CCA) to confirm whether a channel for transmitting signals is used or not via another eNB or WiFi (Registered Mark) before the eNB transmits some signals. In the CCA, at least energy detection is performed to determine whether or not the channel is used. After the LBT, if there is an unused channel, for example, transmission of a physical downlink shared channel (PDSCH), a physical downlink control channel (PDCCH), a primary synchronization signal (PSS), a secondary synchronization signal (SSS), a reference signal (RF), and the like in a downlink, which are defined in the LTE, is performed. However, in the transmission, a continuous transmission period (Max Burst Length) is regulated by laws in each country. For example, in Japan, in the case of the Institute of Electrical and Electronics Engineers (IEEE) 802.11a/n/ac, the continuous transmission period is less than 4 ms.

One of other configurations is an RRM measurement function. The RRM measurement function is a method for measuring reception quality in a specific cell. Specifically, the measurement of the reception quality is performed by using a reference signal (RS) in the DL. As described above regarding the LBT function, if the channel is not used before transmission of the RS, the RS is transmitted and the period for transmitting the RS is limited. As a method for achieving this, DRS is used. Discovery reference signals (DRS) are reference signals used for, for example, turning on or off a small cell. The DRS are used to perform PSS, SSS, or RS (CRS, CSI-RS) transmission only during a certain period of time.

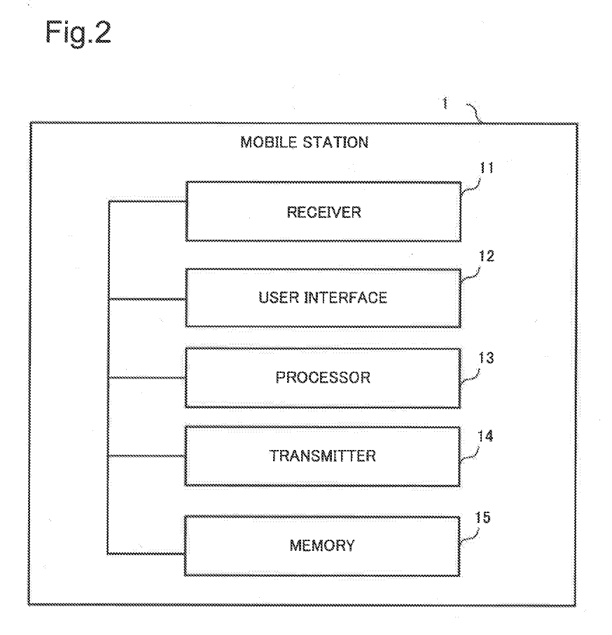

FIG. 2 illustrates a mobile station of the first example embodiment.

The mobile station 1 includes a receiver 11, a user interface 12, a processor 13, a transmitter 14, and a memory 15.

The receiver 11 is configured to be able to receive measurement information for measuring the quality of a signal to be transmitted in a cell from the base station 2.

The user interface 12 is configured to input input information or output output information based on a control signal from the processor 13. Note that the user interface 12 may be a graphical user interface (GUI).

The processor 13 is configured to control various components included in the mobile station 1.

The transmitter 14 is configured to transmit, to the base station 2, information about a cell which the mobile station 1 desires to add, and a measurement result obtained as a result of measuring the signal transmitted in the cell.

The memory 15 is configured to store measurement information received from the base station 2, information to be transmitted to the base station 2, and information to be transmitted and received between various components of the mobile station 1.

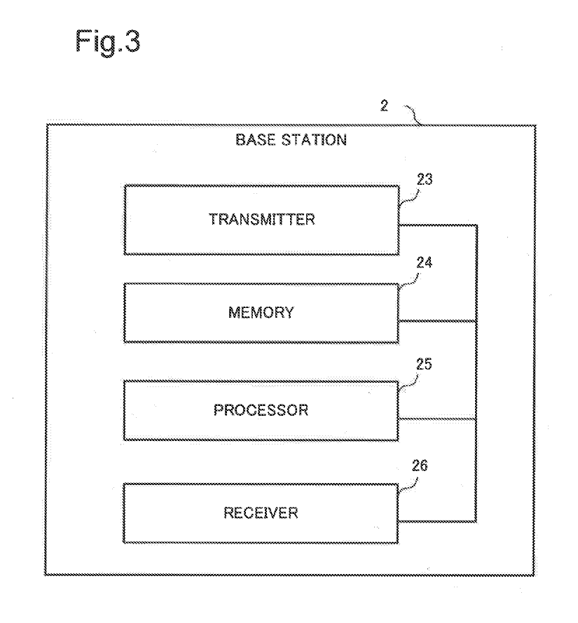

FIG. 3 illustrates a base station of the first example embodiment.

The base station 2 includes a transmitter 23, a memory 24, a processor 25, and a receiver 26.

The transmitter 23 is configured to be able to transmit, to a mobile station, measurement information for measuring the quality of a signal transmitted in a cell.

The memory 24 is configured to store measurement information to be transmitted to the mobile station 1, information received from the mobile station 1, and information to be transmitted and received between various components of the base station 2.

The processor 25 is configured to control various components included in the base station 2. Further, the processor 25 is configured to add a cell based on the information which the base station 2 receives from the mobile station 1.

The receiver 26 is configured to receive, from the mobile station 1, information about the cell which the mobile station 1 desires, and the measurement result obtained as a result of measuring a signal transmitted in the cell.

Note that the base station 2 may have a cooperation function to cooperate with a WiFi access point that is related to or adjacent to the base station 2.

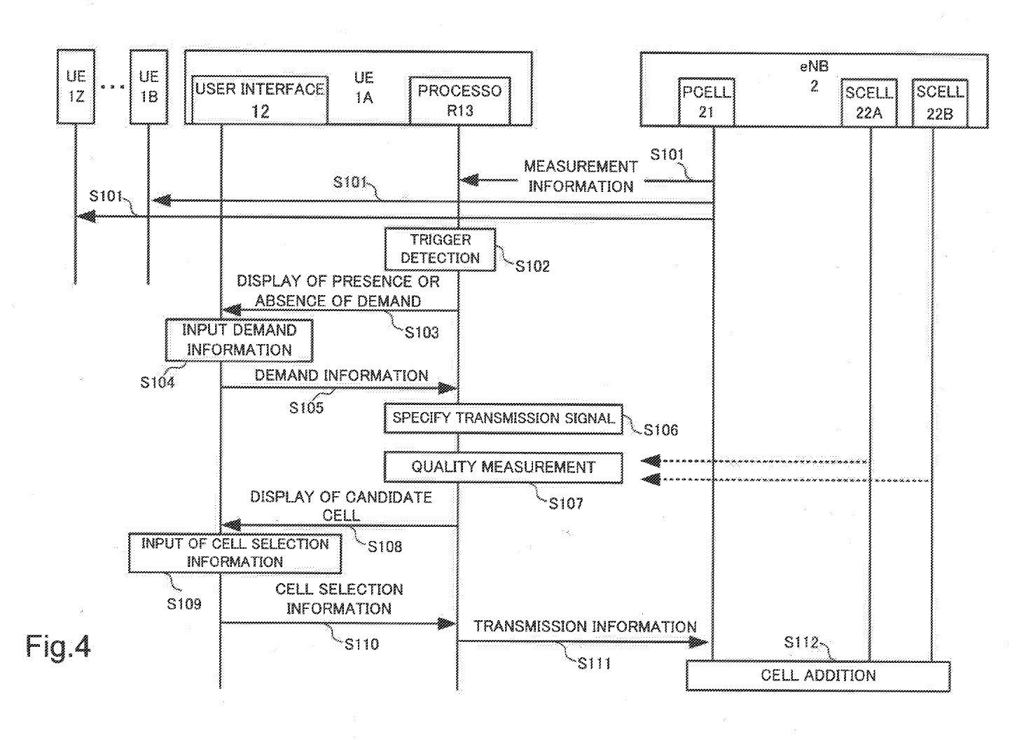

FIG. 4 illustrates an operation of the first example embodiment. For simplicity of explanation about FIG. 4, it is assumed that an Scell 22A and an Scell 22B are LAA-cells.

In S101, the base station 2 (eNB 2) transmits, to the mobile station 1, measurement information for measuring the quality of the signal transmitted in the cell. The measurement information may be included in broadcast information broadcasted in the Pcell 21. The broadcast information is transmitted to at least one of mobile stations 1A, 1B, . . . 1Z which are present in the Pcell. The broadcast information may be system information. The system information may be transmitted at a predetermined cycle.

In this case, the measurement information includes at least one of identification information (Cell ID) for identifying a cell and control information for measuring the quality of the signal transmitted in the cell. The measurement information may include a plurality of pieces of identification information and control information related to the pieces of identification information.

In this case, the control information may include at least one of the following information.
Information about synchronization signals (e.g., PSS, SSS)
Information about reference signals (a cell specific reference signal (CRS) and a channel state information reference signal (CSI-RS))
information about discovery reference signals (DRS)

In this case, the Scell 22 is at least one cell which can be added to the Pcell 21 as an Scell. In the example of FIG. 4, the measurement information includes identification information and control information about the Scell 22A and the Scell 22B which can be added to the Pcell 21. Since the Scell 22A and the Scell 22B are LAA-cells, the measurement information includes a list of DRS about the Scell 22. For example, the list of DRS includes a combination of the identification information (Cell ID) about the Scell 22A and information about the DRS corresponding to the Scell 22A, and a combination of the identification information about the Scell 22B and information about the DRS corresponding to the Scell 22B.

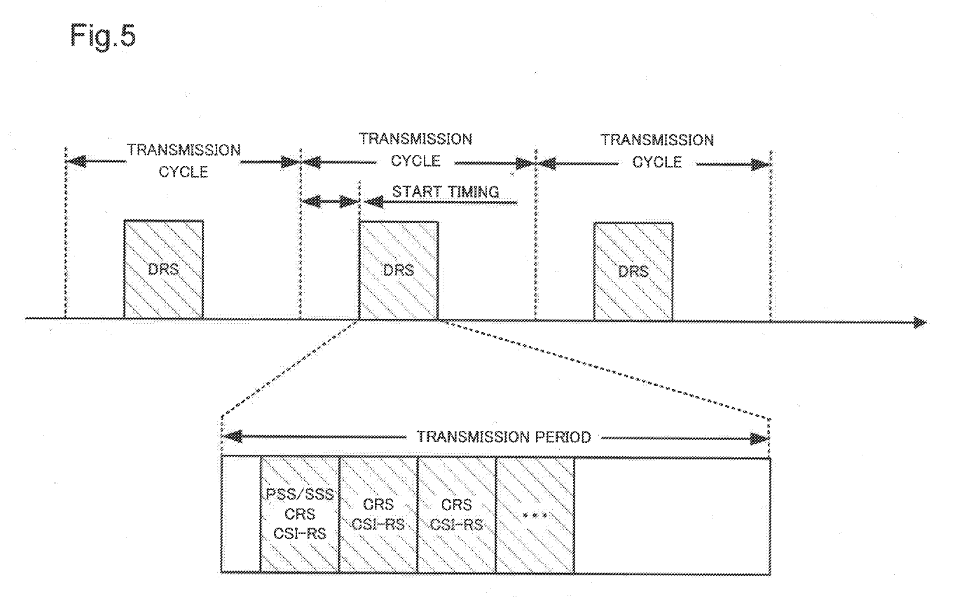

Note that details of the reference signal (DRS) are illustrated in FIG. 5.

FIG. 5 illustrates one example of the reference signal according to the first example embodiment. For the DRS, a specific subframe is set as a period (transmission period) for measurement of the reception quality. In the DRS, transmission of signals in periods other than the period in which signals are periodically transmitted is stopped. The reference signal is composed of PSS, SSS, and CRS. In this case, the reference signal may include CSI-RS.

The “information about DRS” included in the system information described above includes at least one of a transmission cycle of the reference signal, a transmission start timing (also referred to as a transmission timing offset from a reference sub-frame), and a transmission period.

In S102, the processor 13 detects a predetermined trigger. In response to the detected trigger, processing of S103 and subsequent steps is started. The term “trigger” used herein refers to, for example, an occurrence of traffic related to a predetermined service.

In S103, the processor 13 transmits a control signal for controlling the user interface 12 to the user interface 12.

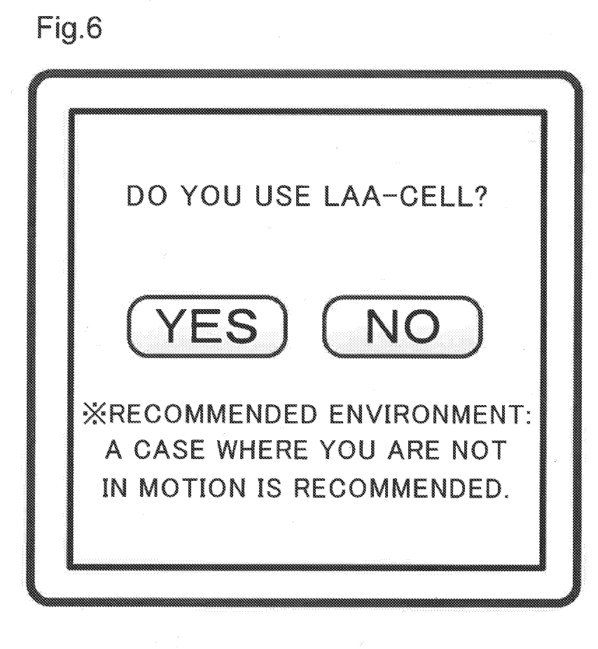

The user interface 12 outputs output information based on the control signal. In this example, the output information is display (display of presence or absence of a request) information requesting for determining whether or not to use the LAA-cell. This display example is illustrated in FIG. 6. In the example of FIG. 6, a comment “DO YOU USE LAA-CELL?” is displayed. As in the example of FIG. 6, the output information may include a display indicating the recommended environment when the LAA-cell is used. In the example of FIG. 6, a comment “A CASE WHERE YOU ARE NOT IN MOTION IS RECOMMENDED” is displayed.

In S104, demand information is input to the user interface 12 as the input information. The demand information is information about the presence or absence of a demand for using the LAA-cell.

In S105, the input demand information is transmitted to the processor 13.

In S106, when the demand information indicates that there is a demand for using the LAA-cell, the processor 13 specifies the transmission signal to be transmitted in the LAA-cell based on the measurement information received in S101. For example, based on the “information about DRS”, the timing for transmitting the reference signal transmitted in the LAA-cell is specified.

In S107, the processor 13 measures the quality of the transmission signal for the transmission signal specified in S106. In the present example, the quality of the reference signal transmitted in the Scell 22A and the Scell 22B is measured.

In S108, the processor 13 transmits a control signal for controlling the user interface 12 to the user interface 12.

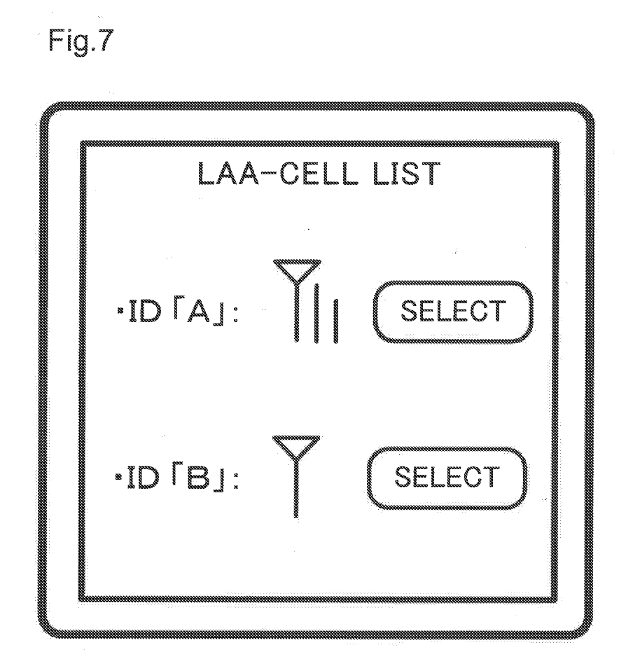

The user interface 12 outputs output information based on the control signal. In this example, the output information is display information on a selection screen for selecting a candidate LAA-cell as a candidate used by the mobile station 1. This display example is illustrated in FIG. 7. In the example of FIG. 7, candidate cells and measurement results obtained as a result of measuring the candidate cells in S107 are displayed (S108). This display enables provision of information for selecting a cell to the user of the mobile station 1.

In S109, cell selection information is input to the user interface 12 as the input information. The cell selection information is information about the cell selected from the candidate cells.

In S110, the input cell selection information is transmitted to the processor 13.

In S111, the processor 13 generates (configures) transmission information based on the input cell selection information. For example, based on the input information input to the user interface 12, information about the cell which the mobile station 1 desires to add as an Scell is included in the transmission information. The transmitter 14 transmits, to the base station 2, the transmission information including information about the cell. The transmission information may include at least one of the identification information (cell ID) about the cell included based on the input information, the measurement result about the cell, and information indicating that there is a desire for adding the cell as an Scell.

In S112, the base station 2 executes the cell addition based on the transmission information received from the mobile station 1. In the case of the present example, processing for adding the cell that is desired to be added as an Scell based on the input information about the mobile station 1 is carried out in the base station 2. In this case, the addition processing is carried out in, for example, an SCell addition procedure using an RRC

### Connection Reconfiguration Procedure.

Note that the cell selection information input in S109 may be information about a plurality of cells selected from the candidate cells. In this case, the processor 13 may include information indicating that each of the plurality of cells is a cell that is desired to be added as an Scell in the transmission information. The transmission information transmitted in S111 may include the identification information about the plurality of cells and the measurement results about the plurality of cells. Thus, when some cells in the plurality of cells which the mobile station 1 desires to add are congested, the base station 2 can add cells other than the congested cells as Scells. For example, when the mobile station desires to add the Scell 22A and the Scell 22B and the Scells 22A are congested, the Scell 22B may be added as an Scell even if the measurement result of the Scell 22B is worse than the measurement result of the Scell 22A. Thus, the base station 2 can add more appropriate cells from the plurality of cells desired by the mobile station 1.

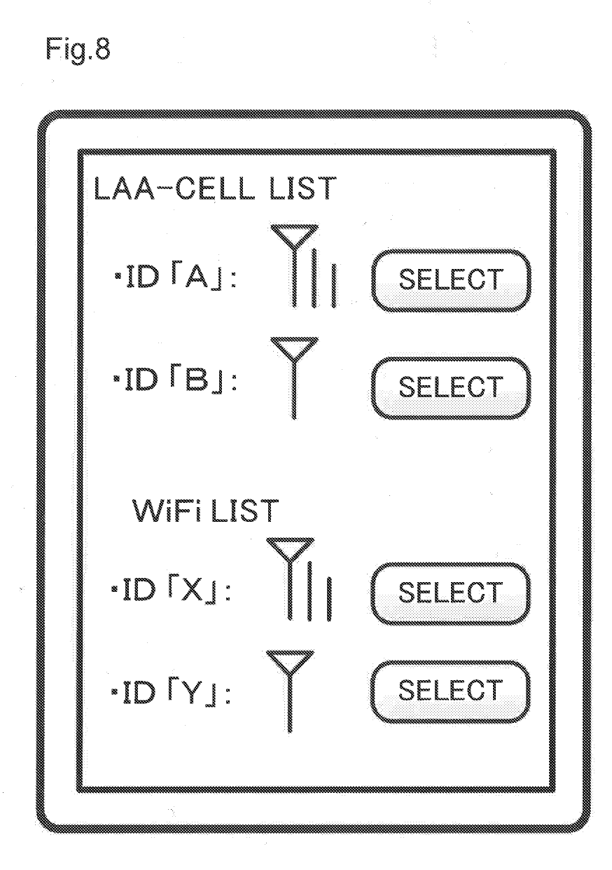

In S107, the measurement about not only the LAA-cell but also WiFi may be performed. For example, when connectable WiFi is detected, a list of LAA-cells and WiFi may be displayed like in a display example of FIG. 8. As a result, the range of options for candidate cells in the cell selection in S109 can be expanded.

The input processing in S103 to S105 and the input processing in S108 to S110 may be skipped by preconfiguration. For example, the configuration (preconfiguration) is performed in such a manner that the LAA-cell is constantly used in FIG. 6 and the LAA-cell with the highest quality is selected in FIG. 7. In this case, the input processing in S103 to S105 and the input processing in S108 to S110 may be skipped. As a result, in the user interface 12, the procedure for confirming the user of the mobile station 1 can be omitted.

For example, such a configuration (preconfiguration) may be performed in the mobile station 1 that is constantly located at the geographically same location, or in the mobile station 1 having little change in movement speed.

The control information for the measurement information transmitted in S101 includes information about the DRS. This control information may include information about cells other than the LAA-cell. For example, the control information may include information about cells, which are similar to the LAA-cell, having a high-frequency band of a licensed frequency band or an unlicensed frequency band. Further, the measurement information may include, for example, information about WiFi.

In S102 described above, detection of an occurrence of traffic about a predetermined service is described as a trigger for the processing of S103 and subsequent steps.

The service may be a service that is provided by a predetermined application used by the mobile station 1. For example, the application may be related to reproduction of a moving image, a game, a video phone, and other services required for predetermined throughputs.

A threshold for traffic related to the application may be set. This threshold may be changed for each application. The trigger may be detected only when the traffic exceeding the threshold is detected.

The mobile station 1 may be provided with a predetermined sensor and the sensor may detect the trigger. For example, the mobile station 1 may be provided with an acceleration sensor, and the trigger may be detected when a deceleration or stop of the mobile station 1 is detected.

When the mobile station 1 operates as a relay device that relays communication of another mobile station, the trigger may be detected depending on the number of relayed mobile stations or the type of mobile stations. For example, the trigger may be detected when the number of mobile stations is greater than a predetermined number. Further, the trigger may be detected when the type of the connected mobile station is a mobile station for a game, or a mobile station for reproducing a moving image.

The trigger may be detected based on other information input from the user. For example, said other information may be information for starting (launching) a predetermined application. In this case, when an input for starting the application is made, the process of S103 and subsequent steps is executed.

In S103 or S108, fee information (charge information) corresponding to the cell may be displayed on the user interface 12. For example, information indicating whether or not to use the LAA-cell in FIG. 6 and fee information about the LAA-cell may be displayed. Further, for example, fee information about each LAA-cell displayed in FIG. 7 may be displayed. Furthermore, for example, fee information about each of the LAA-cell list and the WiFi list illustrated in FIG. 8 may be displayed. Thus, a more appropriate cell can be selected based not only on the cell type and the measurement result in the cell, but also on the fee.

In S103 or S108, category information related to a cell size, such as a macro cell, a pico cell, a small cell, or a femto cell, may be displayed on the user interface 12. The range of movement of the mobile station 1 may be determined in consideration of the cell size.

In S103 or S108, the number of mobile stations that use the cell may be displayed on the user interface 12.

In S103 or S108, the congestion state of cells may be displayed on the user interface 12.

In S103 or S108, a predicted value of the throughput of the mobile station 1 when the mobile station 1 adds a cell may be displayed on the user interface 12. As the predicted value to be displayed, information about a difference between a current throughput and a predicted throughput may be displayed.

In S103 or S108, information about the presence or absence of authentication information necessary for the cell may be displayed on the user interface 12. For example, information indicating that a password and predetermined authentication processing for using the cell are required, or information indicating that authentication processing is not required may be displayed.

The display on the user interface 12 in S103 or S108 may be changed according to the category of the cell.

A comment that “DO YOU USE LAA-CELL?” is displayed in the display example of FIG. 6 in S103. However, the display example is not limited to this example. For example, when cells other than the LAA-cell are used as Scells, a comment “DO YOU WISH TO USE ADDED CELL?” or the like may be displayed. Other examples of the comment include, for example, “DO YOU USE NEW CELL?”, “DO YOU PERFORM CARRIER AGGREGATION?”, “DO YOU WANT TO INCREASE COMMUNICATION SPEED?”, “DO YOU INTEND TO STAND STILL FOR A MOMENT?”, and “DO YOU INTEND TO STAY ON THIS SPOT FOR A MOMENT?”.

According to the example embodiment described above, the base station 2 can add the cell corresponding to the input information in the mobile station 1. For example, the Scell can be added depending on the movement state of the mobile station 1. As a result, addition of a cell in which the mobile station 1 immediately moves out of the coverage area of the cell can be avoided. Further, for example, the mobile station 1 can autonomously transmit, to the base station 2, information about the cell that is demanded to be added.

### Second Example Embodiment

In the first example embodiment described above, the mobile station 1 autonomously performs the measurement of the quality of a signal transmitted in a cell when the mobile station 1 detects a predetermined trigger.

In a second example embodiment, the mobile station 1 performs quality measurement upon receiving a measurement instruction from the base station 2. The measurement result of the quality measurement is transmitted from the mobile station 1 to the base station 2.

The configuration of the second example embodiment is similar to the configuration of the first example embodiment, and thus the description thereof is omitted.

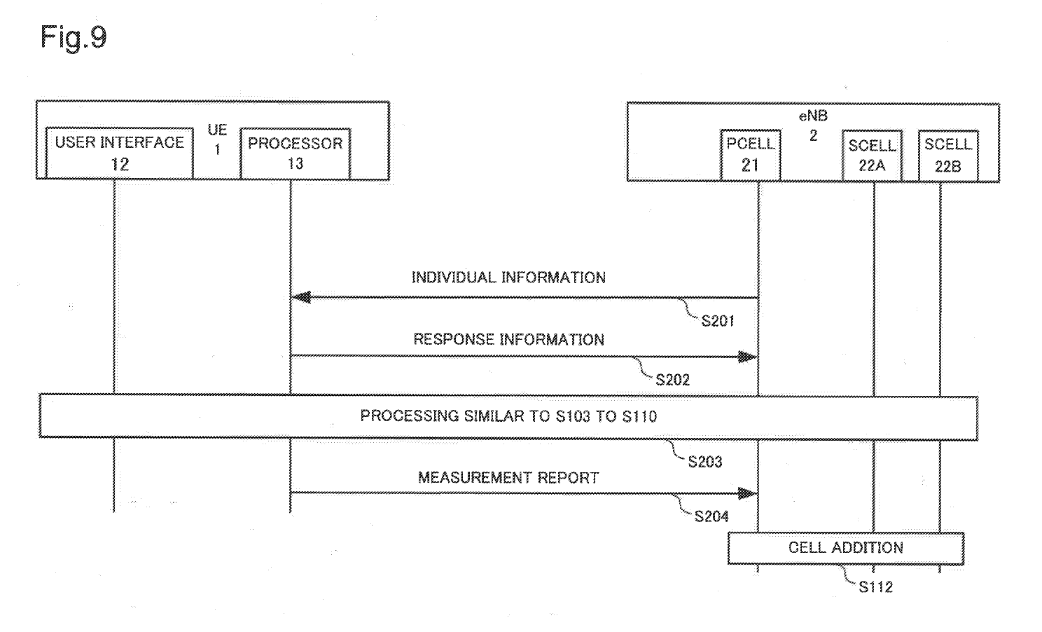

FIG. 9 illustrates an operation of the second example embodiment.

In S201, the base station 2 transmits individual information.

The individual information may include the measurement information in S101 described above. The base station 2 determines the timing for adding the Scell and transmits the individual information to a specific mobile station 1 at the determined timing.

The individual information may include information about a condition (or an event) in which the mobile station 1 transmits the measurement result to the base station 2.

The individual information may be transmitted by an RRC Connection Reconfiguration message.

In S202, the mobile station 1 transmits response information for the received individual information. The response information may be transmitted by an RRC Connection Reconfiguration Complete message.

In S203, processing similar to the processing of S103 to S110 in the first example embodiment described above is executed.

In S204, a measurement report on the cell measured by the mobile station 1 based on the individual information is transmitted to the base station 2. The measurement report is transmitted by a Measurement Report message.

The measurement report may be the transmission information transmitted in S111.

The individual information in S201 may include a skip flag.

The skip flag enables the mobile station 1 to skip the processing of S103 to S105. Further, the skip flag may enable the mobile station 1 to skip the processing of S106 to S110. Furthermore, the skip flag may enable the mobile station 1 to skip the processing of S103 to S105 and S106 to S110.

For example, when the Pcell 21 and the Scell 22 are arranged indoors, the base station 2 determines that the mobile station 1 is “a mobile station that is constantly located at the geographically same location”. In this case, the base station 2 can include the skip flag in the individual information. For example, when the mobile station 1 receives the individual information including the skip flag, the mobile station 1 skips the processing of S103 to S105 based on the skip flag. Thus, the mobile station 1 can determine whether the skip flag is included in the individual information.

For example, the base station 2 may determine whether or not to include the skip flag depending on history information about the cell that is previously used (added) as the Scell by the mobile station 1. The history information may include the identification information about the cell and the time when the cell is added. The base station 2 controls the mobile station 1 to cause the mobile station 1 to measure the quality of the Scell, for example, when the Scell is previously added by the mobile station 1, and to cause the mobile station 1 to send a report to the base station 2 when the quality is equal to or less than certain quality. The base station 2 acquires a certain number of data samples about a period until the report reaches the base station 2. After that, when the average value of the times is equal to or greater than a threshold, the base station 2 may include the skip flag. In this case, the skip flag enables skipping of the processing of S106 to S110. Further, the skip flag may enable skipping of the processing of S103 to S105 and S106 to S110.

As described above, when the skip flag is included in the individual information, the transmission information may be generated in S111 based on the input of the selection information in S109.

Further, when the skip flag is included in the individual information, the transmission information obtained in S111 may be generated based on the input of the demand information in S104.

Further, when the skip flag is included in the individual information, the transmission information may be generated based not on the input processing of S104 and S109, but on the information obtained in S107 carried out on predetermined information, or the like, without performing the input processing of S104 and S109.

The individual information in S201 may include trigger information for transmitting a control signal for controlling the user interface 12 in S103. For example, when the individual information in S201 includes the trigger information, the mobile station 1 executes the process of S103 based on the trigger information included in the individual information, and outputs predetermined display information to the user interface 12.

S201 may be executed based on a predetermined trigger of the base station 2. For example, the base station 2 may detect the predetermined trigger based on the number of mobile stations subordinate to the Pcell 21.

For example, the trigger may be detected when the number of mobile stations subordinate to the Pcell 21 exceeds a predetermined number. Further, for example, the trigger may be detected depending on the traffic state in the Pcell 21. For example, the trigger may be detected when the traffic in the Pcell 21 exceeds a predetermined value.

According to the above example embodiments, the mobile station 1 can generate and transmit the transmission information upon receiving the measurement instruction (individual information) from the base station 2. Further, the input processing in the mobile station 1 can be skipped based on the skip flag included in the individual information.

### Third Example Embodiment

A third example embodiment relates to handover processing in which the mobile station 1 moves between base stations.

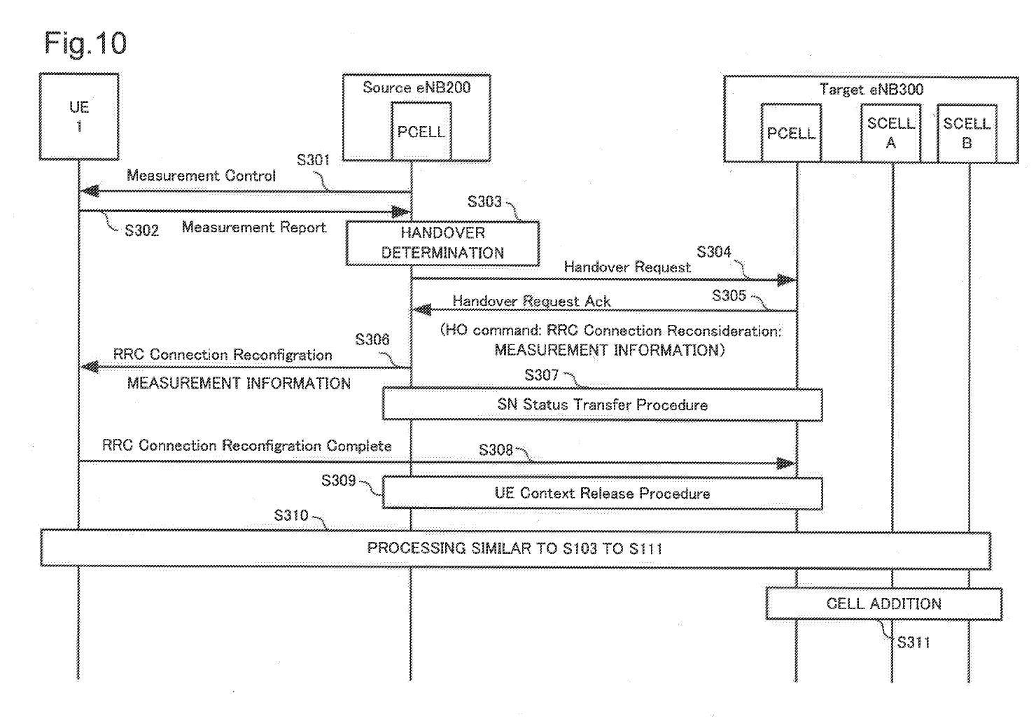

FIG. 10 illustrates an operation of the third example embodiment.

In the example of FIG. 10, the mobile station 1 performs a handover from a source base station 200 to a target base station 300. Specifically, the connection destination of the mobile station 1 is changed from a Pcell of the base station 200 to a Pcell of the base station 300.

In this case, the base station 200 (source base station) and the base station 300 (target base station) include a configuration for executing a handover, in addition to the configuration of the base station 2 illustrated in FIG. 3. For example, the processor 25 is configured to be able to process control information or data related to the handover.

In S301, a Measurement Control message is transmitted to the mobile station 1 present in the Pcell of the base station 200.

In S302, the mobile station 1 transmits the Measurement Report message to the base station 200.

In S303, the base station 200 makes a determination for the mobile station 1 to perform a handover based on the Measurement Report message.

In S304, the base station 200 transmits a Handover Request message to the target base station 300. The Handover Request message includes information necessary for the target base station 300 to prepare for the handover.

In S305, the target base station 300 transmits a Handover Request Acknowledge message to the source base station 200. The Handover Request Acknowledge message includes information corresponding to the measurement information of the above example embodiments. For example, information about DRS is included as the broadcast related information described above.

In S306, the source base station 200 receives the RRC Connection Reconfiguration message. This message includes information corresponding to the measurement information included in S305.

In S307, in an SN Status Transfer procedure, an SN Status Transfer message is transmitted from the source base station 200 to the target base station.

In S308, the mobile station 1 transmits the RRC Connection Reconfiguration Complete message to the target base station 300 to confirm the handover.

In S309, a UE Context Release procedure is carried out. In this case, resources in the source base station 200 are released.

In S310, processing similar to the processing of S103 to S111 in the first example embodiment is performed.

In S311, processing similar to the processing of S112 in the first example embodiment is performed.

Note that the processing of S309 may be performed in parallel with S310.

According to the present example embodiment, the measurement information of the first example embodiment is included in the information necessary for the handover transmitted from the target base station to the source base station, thereby enabling the mobile station to generate and transmit transmission information based on the measurement information after the execution of the handover.

### Fourth Example Embodiment

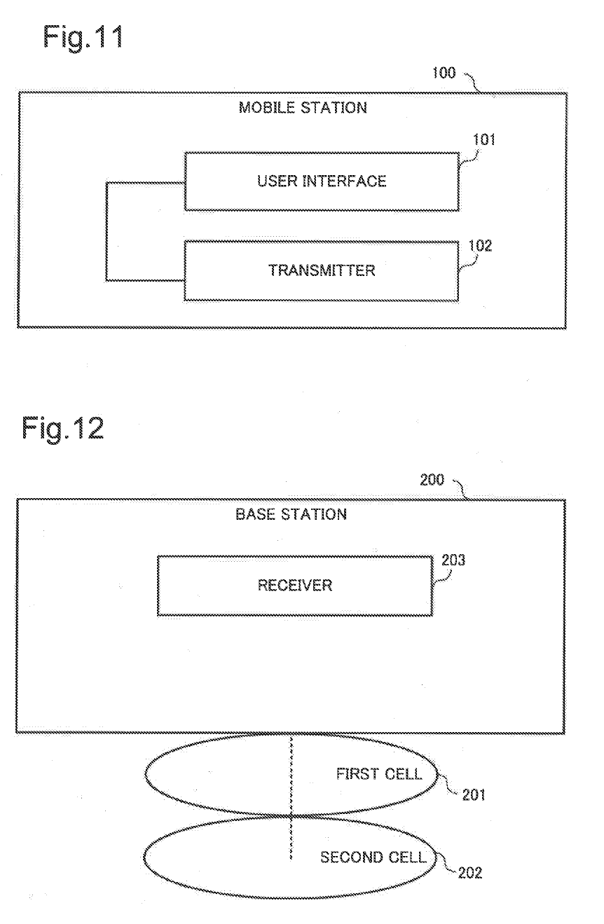

FIG. 11 illustrates a mobile station of a fourth example embodiment.

A mobile station 100 includes a user interface 101 and a transmitter 102.

The user interface 101 is configured to input, when radio communication with a base station is performed by using a first cell having a first carrier wave frequency, input information necessary for performing the radio communication by using the first cell and a second cell having a second carrier wave frequency.

The transmitter 102 is configured to transmit transmission information generated based on the input information.

FIG. 12 illustrates a base station of the fourth example embodiment.

The base station 200 includes a first cell 201, a second cell 202, and a receiver 203.

A first carrier wave frequency is used for the first cell 201.

A second carrier wave frequency is used for the second cell 202.

The receiver 203 is configured to receive, when radio communication with a mobile station is performed by using the first cell, transmission information generated based on input information that is input in the mobile station and is necessary for performing the radio communication by using the first cell and the second cell.

### Other Example Embodiments

In the above example embodiments, transmission information is generated based on input information. The input information may be directly transmitted instead of the transmission information. The input information may be included as one information element of the transmission information. The input information may be changed to predetermined information or a predetermined format, and the changed information may be included in the transmission information.

The input information input to a user interface 12 described above is also referred to as information about a movement of a mobile station. Note that movement information may be information indicating camping in the coverage area of a second cell for a predetermined time. Further, the movement information may be information indicating that the mobile station does not move out of the coverage area of the second cell for the predetermined time.

As for the above-described measurement result, the measurement result obtained as a result of measuring a signal transmitted in a predetermined cell may be generated based on reception quality or a reception signal intensity.

For example, the reception quality may be reference signal received quality (RSRQ) indicating the reception quality of the reference signal. For example, the received signal intensity may be reference signal received power (RSRP).

The above example embodiments describe an example in which the user interface 12 is a graphical user interface (GUI). Specifically, the examples of FIGS. 6 to 8 illustrate an input on a touch panel, but the input is not limited to this. For example, a keyboard, a mouse, a controller, a pen tablet, or a microphone may be used. For example, in the case of a microphone, the microphone inputs audio. The examples of FIGS. 6 to 8 illustrate a display on the display of the mobile station 1 as an example of the output of the user interface 12, but the output is not limited to this. For example, audio or music may be output.

The user interface 12 is configured to perform the input and the output, but instead may be configured as separate devices for an input function (input device) and an output function (output device).

The communication is not limited to the CA of LTE, as long as a technique in which communication is performed by using a sub-cell in addition to a main cell is employed. For example, the present invention is also applicable to a channel bonding technique of a wireless LAN technique. In channel bonding, communication can be performed by using two or more channels in the frequency band used by wireless LAN.

When the transmission information transmitted from a mobile station to a base station includes information about WiFi, carrier aggregation may be performed between cells that cover the WiFi area. Only a predetermined communication may be switched for cells that cover the WiFi area, without performing carrier aggregation.

While the above example embodiments describe a radio communication system of an LTE scheme, at least some of the methods and devices according to various example embodiments can be applied to a wide variety of communication systems including at least either one of many non-LTE and non-cellular systems. For example, the above example embodiments may be applied to a universal mobile telecommunications system (UMTS) method. Further, the above example embodiments may be applied to a radio communication system that employs a frequency division duplex (FDD) method in which different frequencies are simultaneously used in an uplink and a downlink. Furthermore, the above example embodiments may be applied to different radio communication systems (e.g., WiFi, worldwide interoperability for microwave access (WiMAX), IEEE 802.16m) that employ a time division duplex (TDD) method in which the same frequency is used in an uplink and a downlink at different times.

The above example embodiments can be applied not only to a downlink CA, but also to an uplink CA.

The small cell in the above example embodiments indicates a narrow coverage area (cell) formed by low transmission power transmitted by the base station. In the above example embodiments, a macro cell overlays a small cell. However, the arrangement relationship between the cells is not limited to this. A micro cell which is smaller than the macro cell may overlay the small cell, or a small cell may covers an area outside of the coverage of the macro cell without overlaying the small cell with the macro cell. Note that the small cell base station may be provided, for example, at a hot spot where terminals are congested, or indoors where the radio quality is often poor.

The above-described frequency band may include at least one of arbitrary frequency bands. For example, in addition to the frequency band, such as an 800-MHz band or 2-GHz band, which are already in operation, a high-frequency band, such as a 3.5-GHz band, may be selected. The frequency band to be used is not limited to these frequency bands. For example, when a high-frequency band is selected, communication can be performed at a higher speed and a larger capacity.

Further, as in an example of a component carrier in carrier aggregation, a predetermined band width included in a specific frequency band may be referred to as a frequency band. For example, the frequency band to be selected may be a frequency band allocated to each communication standard or each operator.

The above-described mobile station may also be referred to as a radio terminal, a mobile terminal, or a user terminal (or a user). The terminals may include a part or the whole of functionalities of a system, a subscriber unit, a subscriber station, a mobile station, a wireless terminal, a mobile device, a node, a device, a remote station, a remote terminal, a wireless communication device, a wireless communication device, a wireless communication apparatus, or a user agent. The terminals may be at least one of a cellular phone, a cordless phone, a session start protocol (SIP) phone, a smartphone, a wireless local loop (WLL) station, a mobile information terminal (PDA), a laptop, a tablet, a netbook, a smartbook, a hand-held communication device, a hand-held computing device, a satellite radio, a wireless modem card and an other processing device that performs communication via a wireless system. Note that the above example embodiments describe an example in which the operator of the terminal owns one terminal, but the present invention is not limited to this example. One terminal may be shared by a plurality of operators.

Further, the base station can be used for communication with one or more wireless terminals and may include a part or the whole of functionalities of an access point, a node, an evolved node B(eNB), or other network entities. The base station communicates with the UE via an air interface. This communication may occur through one or more sectors. The base station converts a received air interface frame into an IP packet, thereby enabling operation as a router between the UE and the remaining access networks that may include an Internet protocol (IP) network. The base station can adjust the management of an attribute for air interface and may be a gateway between a wired network and a wireless network.

The above-described mobile station, base station, and radio communication system can be implemented by using hardware, software, or a combination of hardware and software. The communication method for the above-described mobile station, base station, and radio communication system can also be implemented by using hardware, software, or a combination of hardware and software. In this case, implementing by using software indicates that a computer loads a program and executes the program.

The program can be stored and provided to a computer by using various types of non-transitory computer readable media. Non-transitory computer readable media include various types of tangible storage media. Examples of non-transitory computer readable media include magnetic storage media (such as flexible disks, magnetic tapes, and hard disk drives), optical magnetic storage media (e.g., magneto-optical disks), CD-ROM (Compact Disc-Read Only Memory), CD-R (Compact Disc-Recordable), CD-R/W (Compact Disc-Rewritable), DVD-ROM (Digital Versatile Disc-ROM), DVD-R (Digital Versatile Disc-Recordable), DVD-R/W (Digital Versatile Disc-Rewritable), and semiconductor memories (such as mask ROM, PROM (Programmable ROM), EPROM (Erasable PROM), flash ROM, and RAM (Random Access Memory)).

The program may be provided to a computer by using various types of transitory computer readable media. Examples of transitory computer readable media include electric signals, optical signals, and electromagnetic waves. Transitory computer readable media can provide the program to a computer via a wired communication line, such as an electric wire and an optical fiber, or a wireless communication line.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### SUPPLEMENTARY NOTES

The whole or part of the example embodiments described above can be described as, but not limited to, the following supplementary notes. However, the following supplementary notes of the present invention are described by way of example only and the present invention is not limited to the supplementary notes.

### (Supplementary Note 1)

A radio communication system comprising:

a mobile station; and

a base station including a first cell having a first carrier wave frequency and a second cell having a second carrier wave frequency,

wherein the mobile station inputs, when radio communication with the base station is performed by using the first cell, input information necessary for performing the radio communication by using the first cell and the second cell, and transmits transmission information generated based on the input information, and

wherein the base station receives the transmission information.

### (Supplementary Note 2)

A mobile station comprising:

a user interface configured to input, when radio communication with a base station is performed by using a first cell having a first carrier wave frequency, input information necessary for performing the radio communication by using the first cell and a second cell having a second carrier wave frequency; and

a transmitter configured to transmit transmission information generated based on the input information.

### (Supplementary Note 3)

The mobile station according to supplementary note 2, wherein information for prompting input of the input information is output to the user interface before the input information is input.

### (Supplementary Note 4)

The mobile station according to supplementary note 2 or 3, wherein the second cell is selected from candidate cells as at least one candidate, and

information about the candidate cells is output to the user interface before the selection is performed.

### (Supplementary Note 5)

The mobile station according to supplementary note 4, further comprising

a receiver configured to receive measurement information for measuring quality of a signal to be transmitted in the candidate cell.

### (Supplementary Note 6)

The mobile station according to supplementary note 5,

wherein the measurement information is included in at least one of individual information transmitted from the base station to the mobile station and broadcast information transmitted in a downlink.

### (Supplementary Note 7)

The mobile station according to supplementary note 5 or 6,

wherein the measurement information includes information for finding a reference signal transmitted in the candidate cell.

### (Supplementary Note 8)

The mobile station according to supplementary note 6 or 7, when flag information for skipping input of the input information is included in the individual information, input of the input information is skipped, and the transmission information is generated based on the flag information.

### (Supplementary Note 9)

The mobile station according to any one of supplementary notes 2 to 8,

wherein the transmission information includes a measurement result of quality of a signal to be transmitted in the second cell.

### (Supplementary Note 10)

The mobile station according to any one of supplementary notes 2 to 9,

wherein the transmission information includes request information for requesting the base station to use the second cell for the radio communication.

### (Supplementary Note 11)

The mobile station according to any one of supplementary notes 2 to 10,

wherein the input information includes information indicating that the mobile station is present in a coverage area of the second cell for a predetermined time or longer.

### (Supplementary Note 12)

A base station comprising:

a receiver configured to receive, when radio communication with a mobile station is performed by using a first cell having a first carrier wave frequency, transmission information generated based on input information that is input in the mobile station and necessary for performing the radio communication by using the first cell and a second cell having a second carrier wave frequency.

### (Supplementary Note 13)

The base station according to supplementary note 12, comprising a transmitter configured to transmit, to the mobile station, information for causing the mobile station to skip processing for inputting the input information.

### (Supplementary Note 14)

The base station according to supplementary note 13,

wherein the transmitter transmits measurement information for measuring reception quality of the second cell to the mobile station.

### (Supplementary Note 15)

The base station according to supplementary note 14,

wherein the measurement information is included in at least one of individual information transmitted to the mobile station and broadcast information in a downlink.

### (Supplementary Note 16)

The base station according to supplementary note 14 or 15,

wherein the measurement information includes information for finding a reference signal transmitted in the second cell.

### (Supplementary Note 17)

The base station according to supplementary note 16, 17,

wherein the information for finding the reference signal includes at least one of a transmission cycle of the reference signal, a timing when the transmission of the reference signal is started, and a period in which the reference signal is transmitted.

### (Supplementary Note 18)

The base station according to any one of supplementary notes 12 to 17,

wherein the transmission information includes request information indicating a request for the mobile station to use the second cell for the radio communication.

### (Supplementary Note 19)

A user interface performs, when radio communication with a base station is performed by using a first cell having a first carrier wave frequency, display for inputting input information necessary for using the first cell and a second cell having a second carrier wave frequency for the radio communication.

### (Supplementary Note 20)

The user interface according to supplementary note 19,

wherein the user interface outputs information for prompting input of the input information before the input information is input.

### (Supplementary Note 21)

The user interface according to supplementary note 19 or 20,

wherein the second cell is selected from candidate cells as at least one candidate, and

wherein the user interface outputs information about the candidate cells before the selection is performed.

### (Supplementary Note 22)

The radio communication system according to supplementary note 1,

wherein information for prompting input of the input information is output to a user interface of the mobile station before the input information is input.

### (Supplementary Note 23)

The radio communication system according to supplementary note 22,

wherein the second cell is selected from candidate cells as at least one candidate, and

wherein information about the candidate cells is output to the user interface before the selection is performed.

### (Supplementary Note 24)

The radio communication system according to any one of supplementary notes 1, 22, and 23,

wherein when the mobile station receives flag information for skipping input of the input information, input of the input information is skipped, and

wherein the transmission information is generated based on the flag information.

### (Supplementary Note 25)

A communication method for a radio communication system including a mobile station and a base station including a first cell having a first carrier wave frequency and a second cell having a second carrier wave frequency, the communication method comprising:

inputting, when radio communication between the mobile station and the base station is performed by using the first cell, input information necessary for performing the radio communication by using the first cell and the second cell; and

transmitting transmission information generated based on the input information.

### (Supplementary Note 26)

The communication method for the radio communication system according to supplementary note 25,

outputting information for prompting input of the input information before the input information is input.

### (Supplementary Note 27)

The communication method for the radio communication system according to supplementary note 25 or 26,

wherein the second cell is selected from candidate cells as at least one candidate, and

outputting information about the candidate cells before the selection is performed.

### (Supplementary Note 28)

The communication method for the radio communication system according to any one of supplementary notes 25 to 27,

skipping input of the input information when flag information for skipping input of the input information is received, and

wherein the transmission information is generated based on the flag information.

### (Supplementary Note 29)

A communication method for a mobile station, comprising:

inputting, when radio communication with a base station is performed by using a first cell having a first carrier wave frequency, input information necessary for performing the radio communication by using the first cell and a second cell having a second carrier wave frequency; and

transmitting transmission information generated based on the input information.

### (Supplementary Note 30)

The communication method for a mobile station according to supplementary note 29,

outputting information for prompting input of the input information before the input information is input.

### (Supplementary Note 31)

The communication method for a mobile station according to supplementary note 29 or 30,

wherein the second cell is selected from candidate cells as at least one candidate, and

outputting information about the candidate cells before the selection is performed.

### (Supplementary Note 32)

The communication method for a mobile station according to any one of supplementary notes 29 to 31,

skipping input of the input information when flag information for skipping input of the input information is received, and

wherein the transmission information is generated based on the flag information.

### (Supplementary Note 33)

A communication method for a base station including a first cell having a first carrier wave frequency and a second cell having a second carrier wave frequency, the communication method comprising:

receiving, when radio communication with a mobile station is performed by using the first cell, transmission information generated based on input information that is input in the mobile station and necessary for performing the radio communication by using the first cell and the second cell.

### (Supplementary Note 34)

The communication method for the base station according to supplementary note 33,

transmitting information for the mobile station to skip processing for inputting the input information to the mobile station.

### (Supplementary Note 35)

A display method comprising:

performing, when radio communication with a base station is performed by using a first cell having a first carrier wave frequency, display for inputting input information necessary for using the first cell and a second cell having a second carrier wave frequency for the radio communication.

### (Supplementary Note 36)

The display method according to supplementary note 35,

performing the display includes outputting information for prompting input of the input information before the input information is input.

### (Supplementary Note 37)

The display method according to supplementary note 35 or 36,

wherein the second cell is selected from candidate cells as at least one candidate, and

performing the display includes outputting information about the candidate cells before the selection is performed.

### (Supplementary Note 38)

A program causing a computer to execute:

inputting, when radio communication with a base station is performed by using a first cell having a first carrier wave frequency, input information necessary for performing the radio communication by using the first cell and a second cell having a second carrier wave frequency; and

transmitting transmission information generated based on the input information.

### (Supplementary Note 39)

The program according to supplementary note 38,

causing a computer to execute outputting information for prompting input of the input information before the input information is input.

### (Supplementary Note 40)

The program according to supplementary note 38 or 39,

wherein the second cell is selected from candidate cells as at least one candidate, and

wherein the program causes a computer to execute outputting information about the candidate cells before the selection is performed.

### (Supplementary Note 41)

The program according to any one of supplementary notes 38 to 40, causing a computer to execute

skipping, when flag information for skipping input of the input information is received, input of the input information, and

generating the transmission information, based on the flag information.

Further, the present invention is not limited only to the example embodiments described above and can be modified in various ways without departing from the scope of the present invention described above as a matter of course. The functions or at least one of steps and operations in the example embodiments described in the present description need not be executed in a specific order. Some of the elements of the present invention are described or claimed in a singular form. However, each of the elements may be provided in plural number unless otherwise indicated.

This application is based upon and claims the benefit of priority from Japanese patent application No. 2015-244273, filed on Dec. 15, 2015, the disclosure of which is incorporated herein in its entirety by reference.

### REFERENCE SIGNS LIST

1 Mobile station
2 Base station
11 Receiver
12 User interface
13 Output device
14 Memory
15 Processor
16 Transmitter
21 Pcell
22 Scell
23 Transmitter
24 Memory
25 Processor
26 Receiver
100 Mobile station
101 User interface
102 Transmitter
200 Base station
201 First cell
202 Second cell
203 Receiver
204 Processor

1. (canceled)

2. A mobile station comprising:
a user interface configured to input, when radio communication with a base station is performed by using a first cell having a first carrier wave frequency, input information necessary for performing the radio communication by using the first cell and a second cell having a second carrier wave frequency; and
a transmitter configured to transmit transmission information generated based on the input information.

3. The mobile station according to claim 2,
wherein information for prompting input of the input information is output to the user interface before the input information is input.

4. The mobile station according to claim 2,
wherein the second cell is selected from candidate cells as at least one candidate, and
wherein information about the candidate cells is output to the user interface before the selection is performed.

5. The mobile station according to claim 4, comprising
a receiver configured to receive measurement information for measuring quality of a signal to be transmitted in the candidate cell.

6. The mobile station according to claim 5,
wherein the measurement information is included in at least one of individual information transmitted from the base station to the mobile station and broadcast information transmitted in a downlink.

7. The mobile station according to claim 5,
wherein the measurement information includes information for finding a reference signal transmitted in the candidate cell.

8. A base station comprising:
a first cell having a first carrier wave frequency;
a second cell having a second carrier wave frequency; and
a receiver configured to receive, when radio communication with a mobile station is performed by using the first cell, transmission information generated based on input information that is input in the mobile station and necessary for performing the radio communication by using the first cell and the second cell.

9. A user interface performs, when radio communication with a base station is performed by using a first cell having a first carrier wave frequency, display for inputting input information necessary for using the first cell and a second cell having a second carrier wave frequency for the radio communication.

10. (canceled)
